(19) United States
(12) Patent Application Publication
(10) Pub. No.: US 2017/0161769 A1
(43) Pub. Date: Jun. 8, 2017

(54) Methods and Systems for Generating Offers Based on Real-Time Data Collected By a Location-Detecting Network

(71) Applicant: CAPITAL ONE SERVICES, LLC, MCLEAN, VA (US)

(72) Inventors: Erik Johnson, Chicago, IL (US); Scott Pandel, Riverside, IL (US); Donald Hartshorn, Chicago, IL (US); Karen Nickerson, Chicago, IL (US); Shardool Pandit, Chicago, IL (US); William Ryan Page, Chicago, IL (US); Justin Wishne, Chicago, IL (US)

(21) Appl. No.: 15/368,156

(22) Filed: Dec. 2, 2016

Related U.S. Application Data
(60) Provisional application No. 62/262,728, filed on Dec. 3, 2015.

(51) Int. Cl. G06Q 30/02; H04L 29/08; G06K 19/06

(52) U.S. Cl. CPC G06Q 30/0226; G06Q 30/0239; G06Q 30/0235; G06K 19/06112; H04L 67/18; G06K 19/06028

(57) ABSTRACT

Disclosed are systems and methods for generating and offering to customers rewards in exchange for the customer's continued presence in a retail environment. An example rewards system may receive, from a detection system, a notification that a computing device associated with the customer is in a retail environment and, in response, transmit an offer to the computing device that offers the customer a reward in exchange for remaining in the retail environment for at least a predetermined amount of time. The rewards system may receive, from the detection system, real-time data indicating a behavior of the customer in the retail environment, and, from a third-party server, non-real-time data associated with the customer. The rewards system may generate the reward based on the real-time data and the non-real-time data. After the predetermined amount of time, the rewards system may transmit the reward to the computing device.

### CROSS-REFERENCE TO RELATED APPLICATION

This application claims priority to U.S. Provisional Patent Application No. 62/262,728, filed Dec. 3, 2015, the contents of which are hereby incorporated by reference in their entirety.

### BACKGROUND

Typical rewards systems use non-real-time data about customers to offer advertising and/or promotions. For example, a rewards system may rely on demographic information about a customer to determine which advertising and/or promotions should be offered to the customer. Such demographic information may be previously determined and stored at the rewards system and/or a third-party server.

However, typical rewards systems are unable to tailor advertising and/or promotion based on real-time data collected while a customer is present in a retail environment, such as a brick-and-mortar store or an online retail environment. Such rewards systems provide no interface through which such real-time data can be collected from, for example, systems in a retail environment and/or client devices, and typical systems in a retail environment and/or client devices are not equipped to detect and/or provide such real-time data. Further, typical rewards systems are not equipped to process such real-time data to tailor advertising and/or promotions to a customer based on such real-time data. Accordingly, improved rewards systems capable of interfacing with devices collecting such real-time data and of exchanging and processing such real-time data in support of advertising and/or promotion are desired.

### SUMMARY

The disclosed embodiments may include a rewards system for generating and offering to customers rewards in exchange for the customer's continued presence in a retail environment. The rewards system may include a communications interface configured to communicate with at least one of a detection system, at least one third-party server, and a computing device. The rewards system may further include a memory storing instructions and a processor configured to execute instructions to perform a rewards process. The rewards process may include the rewards system receiving, from the detection system, a first detection notification indicating a computing device associated with a customer in a retail environment. The detection notification may uniquely identify the customer. In response to receiving the first detection notification, the rewards system may transmit an offer notification to the computing device for display on a computing device interface. The offer notification may offer the customer a reward in exchange for remaining in the retail environment for at least a predetermined amount of time. The rewards process may further include the rewards system receiving, from the detection system, real-time data associated with the customer indicating a behavior of the customer in the retail environment and obtaining, from the at least one third-party server, non-real-time data associated with the customer. The rewards system may generate the reward based on the real-time data and the non-real-time data. The rewards process may further include the rewards system receiving, from the detection system, a second detection notification indicating the computing device has remained in the retail environment for the predetermined amount of time. In response to receiving the second detection notification, the rewards system may transmit the reward to the computing device for display on the computing device interface.

In another embodiment, a method is disclosed for generating and offering to customers rewards in exchange for the customer's continued presence in a retail environment. The method may include detecting, in a location-detecting network configured in a retail environment, a presence of a computing device associated with a uniquely identified customer. The method may further include, in response to detecting the computing device, transmitting a notification to the computing device. The notification may offer a reward in exchange for remaining in the retail environment for at least a predetermined amount of time. The method may further include obtaining real-time data associated with the customer, the real-time data indicating a behavior of the customer in the retail environment based on a monitored location of the computing device in the location-detecting network. The method may still further include obtaining non-real-time data associated with the customer and generating the reward based on the real-time data and the non-real-time data. The method may further include, after the predetermined amount of time, determining the computing device associated with the customer remains in the location-detecting network configured in the retail environment, and, in response to determining the computing device remains in the location-detecting network configured in the retail environment, transmitting the reward to the computing device.

In another embodiment, a computing device associated with a customer is disclosed for receiving rewards in exchange for the customer's continued presence in a retail environment. The computing device may include a location-detecting network interface, a rewards system interface, a display, a memory storing instructions, and a processor configured to execute instructions to perform a rewards process. The rewards process may include, in the retail environment, emitting, via the location-detecting network interface, a signal uniquely identifying the customer. In response to emitting the signal, the computing device may receive, from a rewards system via the rewards system interface, an offer notification. The offer notification may offer the customer a reward in exchange for remaining in the retail environment for at least a predetermined amount of time. The rewards process may further include, during the predetermined amount of time, the computing device continuing to emit, via the location-detecting network interface, the signal and receiving, from the rewards system via the rewards system interface, the reward. After the predetermined amount of time, the computing device may display, via the display, the reward.

Aspects of the disclosed embodiments may include tangible computer-readable media that store software instructions that, when executed by one or more processors, are configured to perform and execute one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments.

FIG. 2 is an exemplary network architecture in which real-time data may be collected, consistent with disclosed embodiments.

FIG. 3 is an exemplary network architecture in which a reward may be generated and provided to a customer, consistent with disclosed embodiments.

FIG. 4 is a block diagram of an exemplary rewards system, consistent with disclosed embodiments.

FIG. 5 is a block diagram of an exemplary computing device, consistent with disclosed embodiments.

FIG. 6 is a flowchart of an exemplary reward process, consistent with disclosed embodiments.

FIG. 7 illustrates an exemplary retail environment, consistent with disclosed embodiments.

FIG. 8 is a flowchart of another exemplary reward process, consistent with disclosed embodiments.

FIGS. 9A-F illustrate exemplary interfaces on a computing device, consistent with disclosed embodiments.

### DETAILED DESCRIPTION

Reference will now be made in detail to the disclosed embodiments, examples of which are illustrated in the accompanying drawings.

Disclosed are rewards systems, detection systems, and third-party servers that are configured to collect, exchange, and process real-time data in connection with promotion and/or advertising. Unlike typical merchant systems, which are not equipped to collect, exchange, and/or process such real-time data to tailor advertising and/or promotions to a customer based on such real-time data, the disclosed rewards system may be configured to interact with the disclosed detection system to obtain real-time data indicating a behavior of a customer in a retail environment, to interact with the third-party server to obtain non-real-time data, and to process the real-time and non-real-time data to generate a reward for display by a computing device. Moreover, the disclosed rewards system may be configured to detect, through the detection system, real-time data indicating the customer's continued behavior in the retail environment and, based on the customer's continued behavior, make the reward available to the customer through a computing device.

While the following discussion is directed to retail environments associated with merchants, discussion of these services and environments are made by example only. The system and methods discussed herein may be just as applicable in other environments that may benefit from the ability to generate offers based on a customer's (or other user's) behavior in the environment, such as a convention, fair, hotel/resort, event, transit hub, etc.

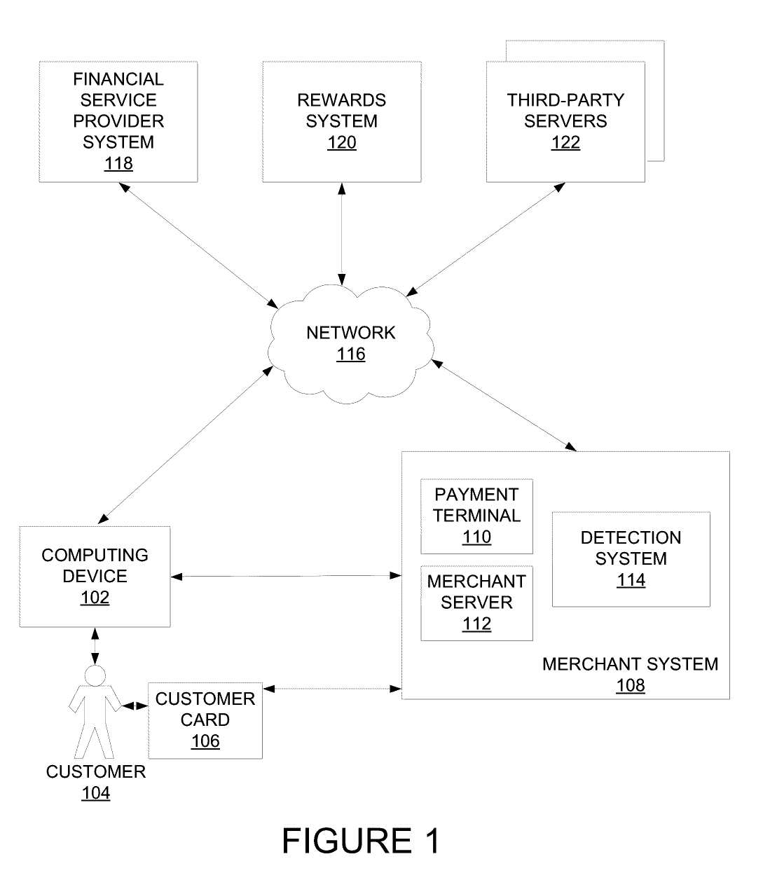

FIG. 1 is a block diagram of an exemplary system 100, consistent with disclosed embodiments. In particular, the system 100 may be configured for performing one or more operations consistent with the disclosed embodiments. In one embodiment, system 100 may include a computing device 102, a merchant system 108, a financial service provider (FSP) system 118, a rewards system 120, and third-party server(s) 122, all of which may be communicatively coupled by a network 116.

While only one computing device 102, merchant system 108, FSP system 118, and rewards system 120 are shown, it will be understood that the system 100 may include more than one of any of these components. Further, while multiple third-party servers 122 are shown, it will be understood that system 100 may include only one third-party server 122 as well. The components and arrangement of the components included in system 100 may vary. Thus, system 100 may include other components that perform or assist in the performance of one or more processes consistent with the disclosed embodiments.

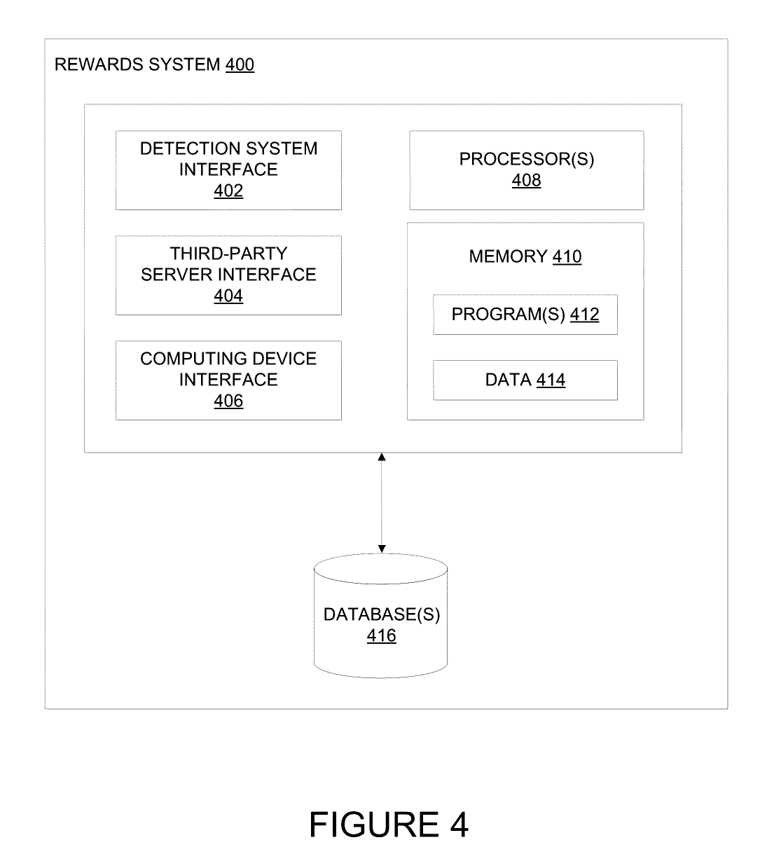

As shown, the computing device 102 may be associated with a customer 104 and/or a customer card 106. While customer card 106 is shown separately from computing device 102, in some embodiments computing device 102 may include customer card 106 (e.g., when configured as a payment device, digital wallet, etc.). Each of computing device 102 and customer card 106 may uniquely identify the customer 104. Computing device 102 is further described below in connection with FIG. 4.

Customer card 106 may comprise a financial services product associated with a financial service account of customer 104, such as a financial card, key fob, smartcard, etc. For example, customer card 106 may comprise a credit card, debit card, loyalty card, or any other financial product associated with conducting transactions. In some embodiments, customer card 106 may comprise a digital wallet such that, for example, computing device 102 and customer card 106 are the same. In other embodiments, customer card 106 need not comprise a financial services product at all. Customer card 106 may be any device configured to communicate with a merchant system 108 in the disclosed embodiments. Customer card 106 is not limited to a card configuration and may be provided in any form capable of being configured to perform the functionality of the disclosed embodiments. In some embodiments, customer card 106 may also include any wearable item, including jewelry, or any other device suitable for carrying or wearing on a customer's person.

Customer 104 may visit a retail environment associated with a merchant. The merchant may be any entity that offers goods, services, and/or information, such as a retailer (e.g., Macy's®, Target®, etc.), grocery store, or any other type of entity that offers goods and/or services for purchase by customers. The retail environment may be, for example, a physical retail location of the merchant, such as a brick-and-mortar store. Alternatively or additionally, the retail environment may include a number of physical retail locations, such as brick-and-mortar stores, and/or nearby indoor or outdoor areas, such as a shopping mall, a strip mall, stores within a particular vicinity, or other physical locations. Still alternatively or additionally, the retail environment may be, for example, an online retail environment, such as a webpage provided by the merchant. Other retail environments are possible as well.

The merchant may be associated with a merchant system 108, as shown. Merchant system 108 may include a payment terminal 110, a merchant server 112, and a detection system 114. Payment terminal 110 may be one or more computing devices configured to perform one or more operations consistent with conducting transactions associated with merchant system 108. For example, payment terminal 110 may comprise one or more point-of-sale (POS) terminals configured to enable purchase transactions, e.g., to accept payment from customer 104 associated with the sale of an item, service, and/or information at the merchant. Further, payment terminal 110 may be configured to accept a reward from computing device 102 during a purchase transaction. The reward may be, for example, a coupon. Other possible rewards may include loyalty points associated with the merchant or financial service provider, free items, access to an event, gift cards, etc. Payment terminal 110 may be configured to perform other processes as well.

Merchant server 112 may be one or more computing devices configured to perform one or more operations consistent with processing purchase transactions at payment terminal 110 and storing and processing real-time data collected by detection system 114. In some embodiments, merchant server 112 may alternatively or additionally include one or more computing systems configured to perform one or more operations consistent with maintaining non-real-time data associated with customer 104. Non-real-time data may include, for example, demographic information associated with customer 104, such as a name, age, gender, location, etc., of customer 104. Alternatively or additionally, the non-real-time data may indicate previous behavior of customer 104 in the retail environment associated with merchant system 108 and/or behavior of customer 104 in at least one additional retail environment. The behavior of customer 104 may include, for example, movement of customer 104 within the retail environment(s), purchases by customer 104 in the retail environment(s), frequency or duration of visits by customer 104 to the retail environment(s), etc. Alternatively or additionally, the behavior of the customer 104 may include items contemplated by the customer 104 but never purchased. To this end, products picked by a customer and/or placed into a customer's “shopping cart” (or other mechanism) may be tracked. Other behavior is possible as well. In some embodiments, the at least one additional retail environment may include an online retail environment. In these embodiments, the behavior of the customer 104 may further include, for example, browsing of customer 104 within the retail environment and items placed in the customer's “shopping cart” but never purchased. Other non-real-time data is possible as well.

Detection system 114 may include one or more computing systems configured to perform one or more operations consistent with detecting computing device 102 and/or customer card 106 in the retail environment and collecting real-time data associated with customer 104. Real-time data may include any information describing behavior of customer 104 in the retail environment, such as movement of customer 104 in the retail environment. Other real-time data is possible as well.

While detection system 114 is depicted as part of merchant system 108, in some embodiments, detection system 114 may be integrated with rewards system 120 instead.

As shown, each of computing device 102 and merchant system 108 may be communicatively coupled to FSP system 118 over network 116. FSP system 118 may be associated with a financial service entity that provides, maintains, manages, or otherwise offers financial services. For example, the financial service entity may be a bank, credit card issuer, or any other type of financial service entity that generates, provides, manages, and/or maintains financial service accounts for one or more customers. Financial service accounts may include, for example, credit card accounts, loan accounts, checking accounts, savings accounts, reward or loyalty program accounts, and/or any other type of financial service account known to those skilled in the art.

FSP system 118 may be one or more computing devices configured to perform one or more operations consistent with maintaining financial service accounts, including a financial service account associated with customer 104. FSP system 118 may be further configured to generate content for a display device included in, or connected to, computing device 102. For example, FSP system 118 may provide content through a mobile banking application on computing device 102. Alternatively or additionally, FSP system 118 may provide content through one or more web sites or online portals that are accessible by computing device 102 over network 116. FSP system 118 may be one or more computing devices further configured to authenticate financial transactions associated with financial service accounts. In particular, FSP system 118 may be configured to authenticate financial transactions associated with customer's 104 financial service account and merchant system 108. FSP system 118 may be further configured to maintain non-real-time data associated with customer 104, such as demographics associated with customer 104, account information associated with customer 104, and purchase transaction history for customer 104. The disclosed embodiments are not limited to any particular configuration of FSP system 118.

Third-party servers 122 may include one or more computing systems configured to perform one or more operations consistent with maintaining non-real-time data associated with customer 104. Non-real-time data may include, for example, demographic information associated with customer 104, such as a name, age, gender, location, etc., of customer 104. Alternatively or additionally, the non-real-time data may indicate previous behavior of customer 104 in the retail environment associated with merchant system 108 and/or behavior of customer 104 in at least one additional retail environment. The behavior of customer 104 may include, for example, movement of customer 104 within the retail environment(s), purchases by customer 104 in the retail environment(s), frequency or duration of visits by customer 104 to the retail environment(s), etc. Alternatively or additionally, the behavior of the customer 104 may include items contemplated by the customer 104 but never purchased. To this end, products picked by a customer and/or placed into a customer's “shopping cart” (or other mechanism) may be tracked. Other behavior is possible as well. In some embodiments, the at least one additional retail environment may include an online retail environment. In these embodiments, the behavior of the customer 104 may further include, for example, browsing of customer 104 within the retail environment and items placed in the customer's “shopping cart” but never purchased. Other non-real-time data is possible as well.

Third-party servers 122 may be configured to store the non-real-time data and provide it to rewards system 120. Third-party servers 122 may gather non-real-time data from any number of sources, including, for instance, merchant system 108, other merchant systems (not shown), FSP system 118, other FSP systems (not shown), and other third-party servers (not shown). Other sources of non-real-time data are possible as well.

Rewards system 120 may be communicatively coupled to FSP system 118, merchant system 108, computing device 102, and third-party servers 122 over network 116, as shown. Rewards system 120 may include one or more computing systems configured to perform one or more operations consistent with receiving a notification of the computing device 102 and/or customer card 106 in the retail environment from merchant system 108, receiving real-time data from merchant system 108, and receiving non-real-time data from third-party servers 122, FSP system 118, and/or merchant system 108. Rewards system 120 may include one or more computing systems further configured to perform one or more operations consistent with offering rewards to customer 104 in exchange for customer 104 remaining in the retail environment, generating rewards associated with customer 104 based on the real-time data and the non-real-time data, and providing the rewards to computing device 102.

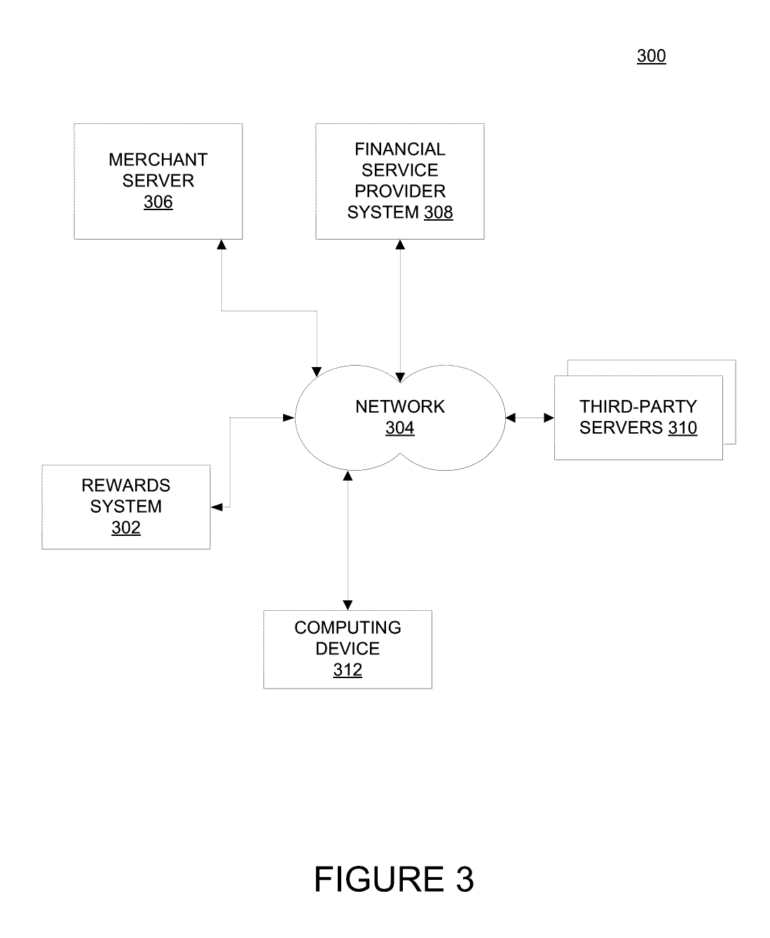

While rewards system 120 and FSP system 118 are shown separately, in some embodiments rewards system 120 may be included in or otherwise related to FSP system 118. Rewards system 120 is further described below in connection with FIG. 3.

Network 116 may be any type of network configured to provide communications between components of system 100. For example, network 116 may be any type of network (including infrastructure) that provides communications, exchanges information, and/or facilitates the exchange of information, such as the Internet, a Local Area Network, near field communication (NFC), optical code scanner, or other suitable connection(s) that enables the sending and receiving of information between the components of system 100. In other embodiments, one or more components of system 100 may communicate directly through a dedicated communication link(s).

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

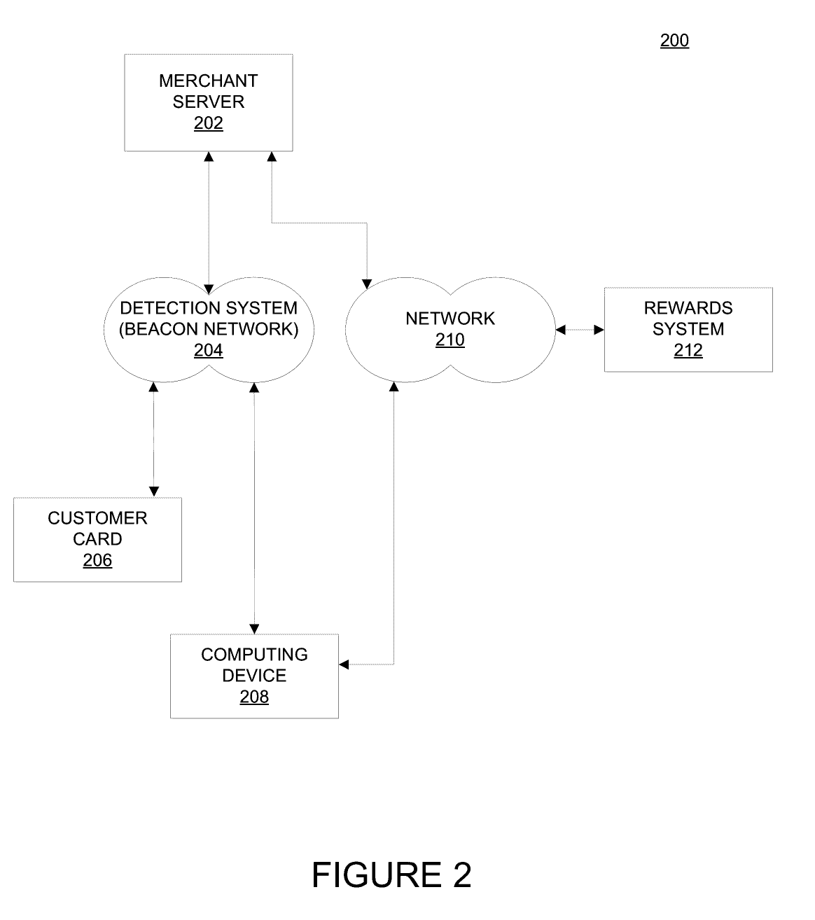

FIG. 2 is an exemplary network architecture 200 in which real-time data may be collected, consistent with disclosed embodiments. Merchant server 202, detection system 204, customer card 206, computing device 208, network 210, and rewards system 212 may be similar to, for example, merchant server 112, detection system 114, customer card 106, computing device 102, network 116, and rewards system 120, respectively, described above in connection with FIG. 1.

Detection system 204 may be configured to detect a customer in a retail environment and collect real-time data associated with the customer. Detection system may include, for example, a location-detecting network within a retail environment associated with a merchant. The location-detecting network may be configured to detect computing device 208 in the retail environment and collect real-time data associated with the customer. In particular, the location-detecting network may uniquely identify the customer. The real-time data may, for example, indicate behavior of the customer in the retail environment, such as movement of the customer within the retail environment.

In some embodiments, such a location-detecting network may operate using one or more of beacons, NFC, radio frequency identification (RFID), infrared, electric fields, magnetic fields, satellite-based location, audio frequency, WiFi, Bluetooth, or any other wireless technology suitable for performing operations consistent with disclosed embodiments. The location-detecting network may operate using any physical or digital, hardware- or software-based location technology, and the disclosed embodiments are not limited to any particular location technology. In some embodiments, the location-detecting network may include hardware, such as location detectors, positioned at separate physical locations within the retail environment. For example, in the case of a location-detecting network using beacons, beacons may be positioned at separate physical locations within the retail environment. Other location detectors are possible as well. Alternatively or additionally, in some embodiments, the location-detecting network may store predetermined data, and the location-detecting network may determine locations with reference to the predetermined data. For example, in the case of a location-detecting network using magnetic fields, a magnetic map of the retail environment may be predetermined, and a location of a customer in the retail environment may be detected in reference to the magnetic map. In some embodiments, no location detectors or other hardware may be used. The location-detecting network may take other forms as well.

Computing device 208 and/or customer card 206 may be configured to emit a signal uniquely identifying the customer, computing device 208, and/or customer card 206. The location-detecting network of detection system 204 may be configured to detect the signal uniquely identifying the customer, computing device 208 and/or customer card 206 and emit communication signals to communicate with and/or track a location of the computing device 208 and/or customer card 206 in the retail environment. By tracking a location of computing device 208 and/or customer card 206, the location-detecting network may track a location of the customer as well.

In one embodiment, the location-detecting network of detection system 204 may generate an electric field that may be amplified by the structural wiring of a merchant, for example, and may sense customer presence and customer interaction by changes in the electric field. For example, a customer carrying computing device 208 and/or customer card 206 may interact with one or more electric fields creating a circuit of a particular capacitance, for example, that may induce a detectable change in the one or more electric fields. In another embodiment, the location-detecting network of detection system 204 may be configured to communicate using a plurality of communication signals of varying technology. In this embodiment, the location of the customer may be determined to varying degrees of specificity as desired.

Detection system 204 may determine, based on communication signals exchanged with computing device 208 and/or customer card 206, that a particular customer is present in the retail environment. For example, the location-detecting network may recognize the identifying signal emitted by computing device 208 and/or customer card 206 and, further, may determine a location of the computing device 208 and/or customer card 206. In embodiments where the location-detecting network uses beacons, for instance, location-detecting network may determine that the computing device 208 and/or customer card 206 is within a predetermined proximity or communication range of a beacon whose location is known. Alternatively or additionally, in embodiments where the location-detecting network uses magnetic fields, for instance, location-detecting network may determine a location of the computing device 208 and/or customer card 206 with reference to a magnetic map. Location-detecting network may determine a location of the computing device 208 and/or customer card 206 in other manners as well

As the customer moves through the retail location, the location-detecting network may continually determine the customer's location in similar manners. The customer's presence in and subsequent locations within the retail environment, as detected by the location-detecting network, may be stored by detection system 204. Detection system 204 may be configured to provide indications of the customer's presence and subsequent locations to merchant server 202. Detection system 204 may communicate with merchant server 202 over, e.g., a Local Area Network (LAN) or direct connection. Other connections are possible as well.

Merchant server 202 may be configured to receive from detection system 204 the indications of the customer's presence in and subsequent locations within the retail environment. Merchant server 202 may process and analyze the indications to determine real-time data associated with the customer. The real-time data may include, for example, movement of the customer within the retail environment, as determined from the locations of the customer detected by detection system 204.

Merchant server 202 may provide a notification of the customer's presence in the retail environment to rewards system 212 over network 210. Merchant server 202 may further provide some or all of the real-time data to rewards system 212 over network 210. Merchant server 202 may provide the real-time data continually or upon request by rewards system 212.

FIG. 3 is an exemplary network architecture in which a reward may be generated and provided to a customer, consistent with disclosed embodiments. Rewards system 302, network 304, merchant server 306, FSP system 308, third-party servers 310, and computing device 312 may be similar to, for example, rewards system 120, network 116, merchant server 112, FSP system 118, third-party servers 122, and computing device 102, respectively, described above in connection with FIG. 1.

Rewards system 302 may be configured to generate a reward for a customer associated with computing device 312 based on real-time data received from merchant server 306 and non-real-time data received from one or more of merchant server 306, FSP system 308, and third-party servers 310.

As described in connection with merchant server 202 of FIG. 2, merchant server 306 may maintain real-time data associated with the customer, and may provide the real-time data to rewards system 302 continually or upon request by rewards system 302. Merchant server 306 may additionally maintain non-real-time data associated with the customer. In some embodiments, the non-real-time data may have been collected during the customer's previous visit(s) to the retail environment. In such embodiments, the non-real-time data may have initially been collected by a detection system, such as detection system 204, in a manner similar to that described above with respect to real-time-data. The non-real-time data may include, for example, previous behavior of the customer in the retail environment, such as previous movement of the customer, or previous purchase transactions associated with the customer. Other non-real-time data is possible as well. Merchant server 306 may provide the non-real-time data to rewards system 212 continually or upon request by rewards system 212.

FSP system 308 may similarly maintain non-real-time data associated with the customer. The non-real-time data may have been collected during, e.g., authorization by FSP system 308 of purchase transactions associated with the customer, the customer's use of a mobile banking application, web site, or online portal provided by FSP system 308, or other interaction between the customer and FSP system 308. The non-real-time data may include, for example, previous purchase transactions associated with the customer, or demographic information associated with the customer, such as a name, age, gender, location, etc., of the customer. Other non-real-time data is possible as well. FSP system 308 may provide the non-real-time data to rewards system 302 continually or upon request by rewards system 302.

Third-party servers 310 may similarly maintain non-real-time data associated with the customer. Third-party servers 310 may be, for example, other FSP systems or other merchant servers. Alternatively, third-party servers 310 may be independent aggregators of data. Third-party servers 310 may maintain non-real-time data generated locally and/or received from any number of sources, including, for instance, merchant server 306, other merchant systems (not shown), FSP system 308, other FSP systems (not shown), and other third-party servers (not shown). Other sources of non-real-time data are possible as well. The non-real-time data may include, for example, previous behavior of the customer within one or more retail environments, such as movement of the customer within the retail environment(s), purchases by the customer in the retail environment(s), and frequency or duration of visits by the customer to the retail environment(s). Other non-real-time data is possible as well. Third-party servers 310 may provide the non-real-time data to rewards system 302 continually or upon request by rewards system 302.

Rewards system 302 may receive real-time and/or non-real-time data from merchant system 306. Rewards system 302 may further receive non-real-time data from one or more of FSP system 308 and third-party servers 310. Based on the real-time data and the non-real-time data, rewards system 302 may generate a reward for the customer. Insofar as the real-time and non-real-time data is associated with the customer, the generated reward reflects the customer's demographics and/or behavior in one or more retail environments, such that the reward is tailored to the customer. Rewards system 302 may provide the reward to computing device 312 over the network 304, as shown. Alternatively or additionally, in some embodiments, the reward transmitted to the computing device may notify the customer that the reward has been associated with the customer in some manner, such as through a financial service account or merchant account that is associated with the customer. The reward may take other forms as well.

FIG. 4 is a block diagram of an exemplary rewards system 400, consistent with disclosed embodiments. As shown, rewards system 400 may include detection system interface 402, third-party server interface 404, computing device interface 406, one or more processor(s) 408, and memory 410 including one or more programs 412 and data 414.

In some embodiments, rewards system 400 may take the form of a server, general purpose computer, mainframe computer, or any combination of these components. Other implementations consistent with disclosed embodiments are possible as well.

Detection system interface 402 may be configured to communicate with one or more detection systems, such as detection systems 114 and 204 described above. In some embodiments, detection system interface 402 may communicate indirectly with a detection system through a merchant server, such as merchant servers 112, 202, and 306 described above, or a merchant system, such as merchant system 108 described above. Other implementations consistent with disclosed embodiments are possible as well.

Third-party server interface 404 may be configured to communicate with one or more third-party servers, such as third-party servers 122 and 310 described above. Similarly, computing device interface 406 may be configured to communicate with one or more computing devices, such as computing devices 102, 208, and 312 described above.

Each of detection system interface 402, third-party server interface 404, and computing device interface 406 may be configured to provide communication over a network, such as networks 116, 210, and 304 described above. To this end, any of detection system interface 402, third-party server interface 404, and computing device interface 406 may include, for example, one or more digital and/or analog devices that allow rewards system 400 to communicate with and/or detect other components, such as a network controller and/or wireless adaptor for communicating over the Internet. In some embodiments, detection system interface 402, third-party server interface 404, and computing device interface 406 may be implemented together as a communications interface configured to communicate with one or more of a detection system, at least one third-party server, and a computing device. Other implementations consistent with disclosed embodiments are possible as well.

Processor(s) 408 may include one or more known processing devices, such as a microprocessor from the Pentium™ or Xeon™ family manufactured by Intel™, the Turion™ family manufactured by AMD™ the “Ax” or “Sx” family manufactured by Apple™, or any of various processors manufactured by Sun Microsystems, for example. The disclosed embodiments are not limited to any type of processor(s) otherwise configured to meet the computing demands required of different components of rewards system 400.

Memory 410 may include one or more storage devices configured to store instructions used by processor(s) 408 to perform functions related to disclosed embodiments. For example, memory 410 may be configured with one or more software instructions, such as program(s) 412, that may perform one or more operations when executed by processor(s) 408. The disclosed embodiments are not limited to separate programs or computers configured to perform dedicated tasks. For example, memory 410 may include a single program 412 that performs the functions of rewards system 400, or program(s) 412 may comprise multiple programs. Memory 410 may also store data 414 that is used by program(s) 412.

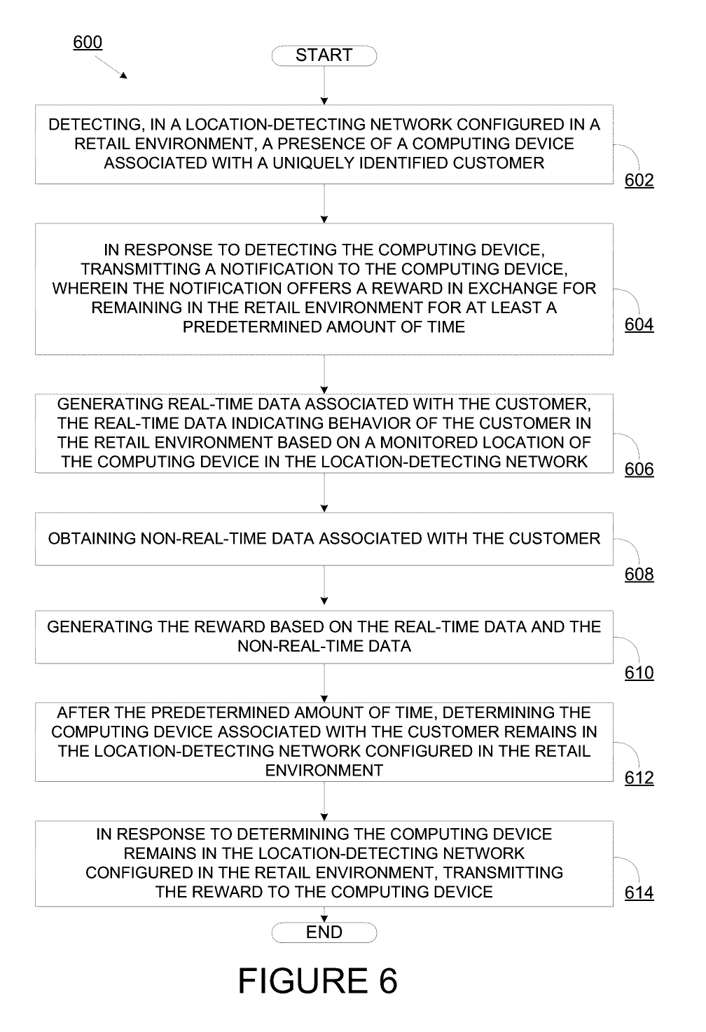

In certain embodiments, memory 410 may store sets of instructions for carrying out the processes described below in connection with FIG. 6. Other instructions are possible as well. In general, instructions may be executed by processor(s) 408 to perform one or more processes consistent with disclosed embodiments.

The components of rewards system 400 may be implemented in hardware, software, or a combination of both hardware and software, as will be apparent to those skilled in the art. For example, although one or more components of rewards system 400 may be implemented as computer processing instructions, all or a portion of the functionality of rewards system 400 may be implemented instead in dedicated electronics hardware.

Rewards system 400 may also be communicatively connected to one or more database(s) 416. In one aspect, rewards system 400 may include database(s) 416. Alternatively, database(s) 416 may be located remotely from the rewards system 400. Rewards system 400 may be communicatively connected to database(s) 416 through a network, such as networks 116, 210, and 304 described above. Database(s) 416 may include one or more memory devices that store information and are accessed and/or managed through rewards system 400. By way of example, database(s) 416 may include Oracle™ databases, Sybase™ databases, or other relational databases or non-relational databases, such as Hadoop™ sequence files, HBase™, or Cassandra™. The databases or other files may include, for example, real-time and non-real-time data associated with customers. The database(s) 416 may include, for instance, databases associated with merchant systems, merchant servers, detection systems, FSP systems, and/or third-party servers. Database(s) 416 may include computing components (e.g., database management system, database server, etc.) configured to receive and process requests for data stored in memory devices of database(s) 416 and to provide data from database(s) 416.

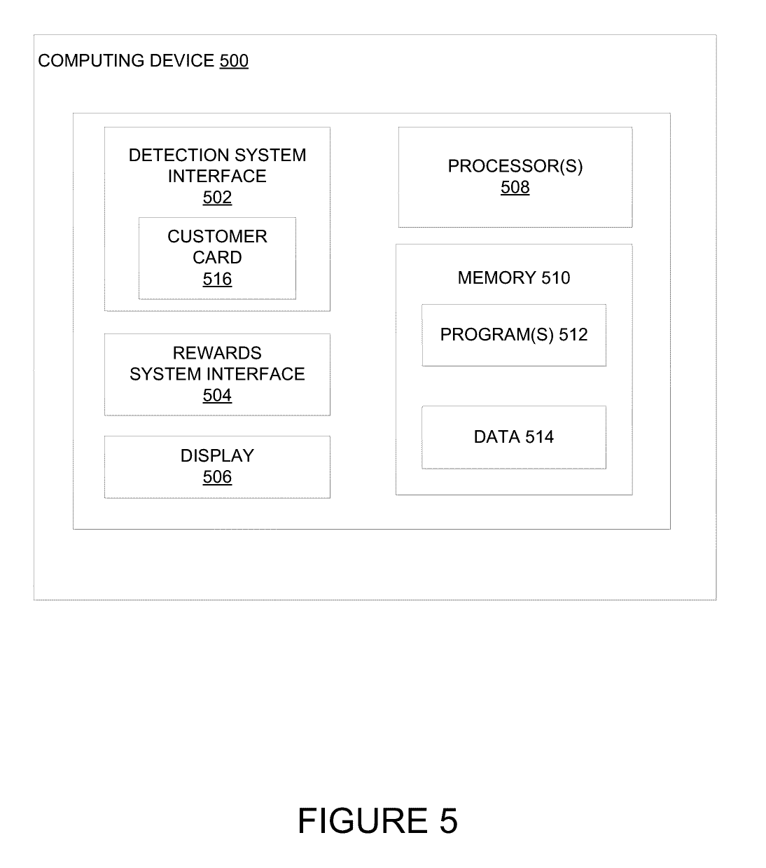

FIG. 5 is a block diagram of an exemplary computing device 500, consistent with disclosed embodiments. As shown, computing device 500 includes detection system interface 502, rewards system interface 504, display 506, processor(s) 508, and memory 510 including program(s) 512 and data 514.

In some embodiments, computing device 500 may take the form of a mobile computing device, such as a smartphone, tablet, laptop computer, or any combination of these components. Alternatively, computing device 500 may be configured as any wearable item, including jewelry, smart glasses, or any other device suitable for carrying or wearing on a customer's person. Other implementations consistent with disclosed embodiments are possible as well. The computing device 500 may be associated with a customer.

Detection system interface 502 may be configured to communicate with one or more detection systems, such as detection systems 114 and 204 described above. To this end, detection system interface 502 may, in some embodiments, include a customer card 516, as shown. Customer card 516 may be similar to customer cards 106 and 206 described above. In some embodiments, customer card 516 may include certain components and circuitry or other technology to allow one or more detection systems to receive information from and track the location of customer card 516 within a retail environment. In other embodiments, customer card 516 may be a passive, low-power device having no internal power source. Other implementations consistent with disclosed embodiments are possible as well.

In some embodiments, detection system interface 502 may be a location-detecting network interface configured to communicate with a location-detecting network associated with a detection system in a retail environment. In these embodiments, the location-detecting network interface may be configured to emit a signal uniquely identifying the customer and/or computing device 500. The signal may be detectable by the location-detecting network. Based on the signal, the location-detecting network may collect real-time data indicating a location of computing device 500. Other implementations consistent with disclosed embodiments are possible as well.

Rewards system interface 504 may be configured to communicate with one or more rewards systems, such as rewards systems 120, 212, 302, and 400. Rewards system interface 504 may be configured to provide communication over a network, such as networks 116, 210, and 304 described above. To this end, rewards system interface 504 may include, for example, one or more digital and/or analog devices that allow computing device 500 to communicate with and/or detect other components, such as a network controller and/or wireless adaptor for communicating over the Internet. Other implementations consistent with disclosed embodiments are possible as well.

Display 506 may be any display device configured to display a reward on computing device 500. In some embodiments, display 506 may include a screen for displaying a graphical and/or text-based user interface. In some embodiments, display 506 may also include one or more digital and/or analog devices that allow a customer, such as customer 104, to interact with computing device 500, such as a touch-sensitive area, keyboard, buttons, or microphones. Display 506 may also include other components known in the art for interacting with a customer. Other implementations consistent with disclosed embodiments are possible as well.

Processor(s) 508 may include one or more known processing devices, such as a microprocessor from the Pentium™ or Xeon™ family manufactured by Intel™, the Turion™ family manufactured by AMD™ the “Ax” or “Sx” family manufactured by Apple™, or any of various processors manufactured by Sun

Microsystems, for example. The disclosed embodiments are not limited to any type of processor(s) otherwise configured to meet the computing demands required of different components of computing device 500.

Memory 510 may include one or more storage devices configured to store instructions used by processor(s) 508 to perform functions related to disclosed embodiments. For example, memory 510 may be configured with one or more software instructions, such as program(s) 512, that may perform one or more operations when executed by processor(s) 508. The disclosed embodiments are not limited to separate programs or computers configured to perform dedicated tasks. For example, memory 510 may include a single program 512 that performs the functions of computing device 500, or program(s) 512 may comprise multiple programs. Memory 510 may also store data 514 that is used by program(s) 512.

In certain embodiments, memory 510 may store sets of instructions for carrying out the processes described below in connection with FIG. 8. Further, in some embodiments, memory 510 may store instructions for executing mobile applications (e.g., a mobile banking application) that provide financial-service-related functions offered by an FSP system, such as FSP systems 118 and 308 described above. These functions may include, for instance, checking balances, paying bills, performing financial transactions, budgeting, receiving marketing messages, etc. Other instructions are possible as well. In general, instructions may be executed by processor(s) 508 to perform one or more processes consistent with disclosed embodiments.

The components of computing device 500 may be implemented in hardware, software, or a combination of both hardware and software, as will be apparent to those skilled in the art. For example, although one or more components of computing device 500 may be implemented as computer processing instructions, all or a portion of the functionality of computing device 500 may be implemented instead in dedicated electronics hardware.

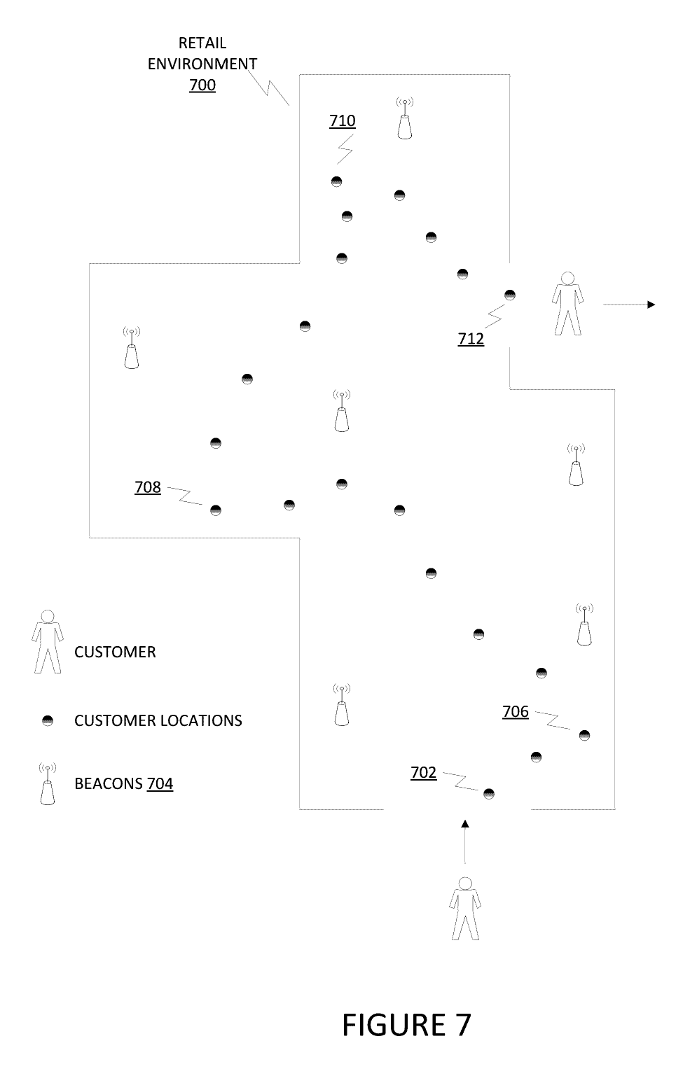

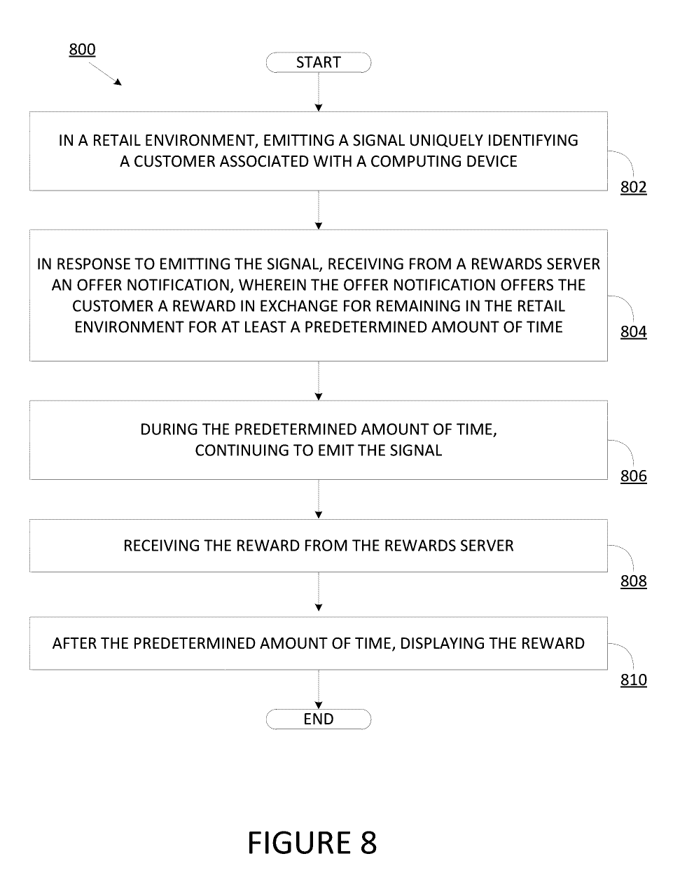

FIG. 6 is a flowchart of an exemplary reward process 600, consistent with disclosed embodiments. Reward process 600 may be carried out at a rewards system, such as rewards systems 120, 212, 302, and 400 described above. FIG. 7 illustrates an exemplary retail environment 700, consistent with disclosed embodiments. Reward process 600 will be described with reference to retail environment 700.

As shown in FIG. 6, the reward process 600 may begin at step 602 with the rewards system detecting, in a location-detecting network configured in a retail environment, a presence of a computing device associated with a uniquely identified customer. In some embodiments, the rewards system may detect the presence of the computing device by receiving from the location-detecting network (or a detection system that includes the location-detecting network) a detection notification indicating that the computing device is in the retail environment. The detection notification may uniquely identify the customer.

Detection of the computing device may be further explained with reference to FIG. 7. As shown in FIG. 7, retail environment 700 may be a physical retail location, such as a brick-and-mortar store. The retail environment 700 may include a location-detecting network that uses beacons 704. While the location-detecting network of FIG. 7 is described with reference to beacons, it will be understood that other location-detecting networks, including other location detectors or no location detectors at all, are possible as well. The beacons 704, as shown, may be positioned throughout the retail environment 700, such that each beacon 704 is associated with a separate physical location in the retail environment. In some embodiments, one or more beacons may be associated with the same physical location of the retail environment. For example, one or more beacons may form a subset of the beacons 704 corresponding to the physical location of a department (e.g., men's, women's, shoes, jewelry, etc.) within the retail environment. Other physical locations are possible as well.

A customer may enter the retail environment 700, as shown. The customer may carry a computing device, such as computing devices 102, 208, 312, and 500 described above, and/or a customer card, such as customer cards 106, 206, and 516 described above. In some embodiments, a customer card may be implemented as and/or within a computing device, as described above. As the customer moves about the retail environment 700, e.g., from user location 702 to user location 706, the computing device carried by the customer may be detected by a beacon 704. In particular, the beacon 704 may receive a transmission from the computing device, such as a signal identifying the customer, computing device, and/or the customer. In response to detecting the computing device, the beacon 704 (or a detection system including the beacon 704) may provide a detection notification to the rewards system. The detection notification may indicate that the computing device associated with the customer is present in the retail environment. The detection notification may uniquely identify the customer.

Returning to FIG. 6, exemplary process 600 continues at step 604 where the rewards system, in response to detecting the computing device, transmits a notification to the computing device. The notification offers a reward in exchange for remaining in the retail environment for at least a predetermined amount of time. The predetermined time may be any amount of time, such as a number of minutes. By offering a reward in exchange for the customer remaining in the retail environment, the rewards system may encourage the customer to continue shopping, thereby increasing the opportunity for the customer to make a purchase and/or encourage the customer's loyalty to the retail environment and/or a merchant associated with the retail environment.

The computing device may display the reward on a display or other interface of the computing device, such as display 506, thereby presenting the offer to the customer. In some embodiments, in response to transmitting the notification, the rewards system may receive from the computing device a response indicating an acceptance of the offer by the customer. In other embodiments, no response may be received.

At step 606, the rewards system obtains real-time data associated with the customer. The real-time data indicates behavior of the customer in the retail environment based on a monitored location of the computing device in the location-detecting network. In some embodiments, the rewards system may obtain the real-time data from a detection system and/or a location-detecting network included in the detection system.

Real-time data may be further explained with reference to FIG. 7. As shown in FIG. 7, the customer may continue to move through the retail environment, as indicated by user locations 708, 710, and 712. As the customer moves through the retail environment, beacons 704 may detect the computing device carried by the customer. For example, at user location 708, a beacon may receive a transmission from the computing device, such as a signal uniquely identifying the computing device and/or the customer. Alternatively or additionally, as the customer moves through the retail environment, each of beacons 704 may broadcast a transmission, such as a signal identifying the beacon, and the computing device may receive transmission from the beacon. Beacons 704 may detect the computing device in other manners as well. In response to detecting the computing device, a beacon 704 (or a detection system including a beacon 704) may determine a location of the customer in the retail environment. The determined location may be inferred from, for example, the physical location within the retail environment associated with the detecting beacon. Similarly, at user locations 710 and 712, other beacons may subsequently detect the computing device and similarly determine current locations of the customer in the retail environment.

Thus, based on the ongoing determined locations of the customer, the customer's movement within the retail environment may be discerned. The real-time data may indicate, for example, this determined movement of the customer within the retail environment. The real-time data thus may indicate which locations the customer has visited in the retail environment, where the customer is currently located within the retail environment, and what location(s) the customer is traveling towards. The real-time data may also indicate how long a user has dwelled in locations in the retail environment. Beacons 704 (or a detection system including beacons 704) may provide the real-time data to the rewards system.

Returning to FIG. 6, exemplary process 600 continues at step 608 where the rewards system obtains non-real-time data associated with the customer. The rewards system may obtain non-real-time data from, for example, one or more third-party servers, such as third-party servers 122 and 310. Alternatively or additionally, the rewards system may obtain non-real-time data from one or more FSP systems, such as FSP systems 118 and 308, including an FSP system having an account associated with the customer. Still alternatively or additionally, the rewards system may obtain non-real-time data from one or more merchant systems, such as merchant system 108, including a merchant system associated with the retail environment.

The non-real-time data may include, for example, demographic information associated with the customer, such as a name, age, gender, location, etc., of the customer. Alternatively or additionally, the non-real-time data may indicate previous behavior of the customer in the retail environment and/or behavior of the customer in at least one additional retail environment. The behavior of the customer may include, for example, movement of the customer within the retail environment(s), purchases by the customer in the retail environment(s), past browsing behavior that may or may not have resulted in a purchase, and frequency or duration of visits by the customer to the retail environment(s). Other non-real-time data is possible as well.

At step 610, the rewards system generates the reward based on the real-time data and the non-real-time data. As an example, the real-time data may indicate that the customer visited a shoe department in the retail environment, and the non-real-time data may indicate that the customer is a regular purchaser of shoes. In this example, the reward may be, for instance, a coupon for a percentage off the price of shoes. As another example, the real-time data may indicate that the customer dwelled in an automotive department in the retail environment, and the non-real-time data may indicate that the customer is an automotive enthusiast. In this example, the reward may be, for instance, a coupon for a free automotive purchase with purchase of another item. In each of these examples, the customer's behavior in the retail environment indicated the customer's potential interest in making a purchase from a particular department, and the non-real-time data confirmed that the customer may be interested in the department more generally. By providing the reward to the customer, the rewards system may encourage the customer to return to the department and, ultimately, make a purchase.

As still another example, the real-time data may indicate that the customer did not visit a linens department of the retail environment, while the non-real-time data may indicate that the customer has previously purchased some items in a linens collection sold in the retail environment. In this example, the reward may be, for instance, loyalty points for purchasing related items in the linens collection. For example, the loyalty points may be related to a pillow cover that matches (or belongs to the same set as) an earlier purchase related to bedspreads. Thus, this example draws a customer to a department of the store that the customer has not visited on this occasion because the non-real-time data demonstrates the customer's past interest in the department. By providing the reward to the customer, the rewards system may encourage the customer to purchase items the customer had not, on this occasion, thought to consider purchasing. Other examples are possible as well.

In some embodiments, the reward generated by the rewards system may be a coupon, discount, reward/loyalty points, legal tender, voucher, access to an event, etc., for a merchant associated with the retail environment. In other embodiments, however, the reward may be for one or more third-party merchants unassociated with retail environment (including operation of the location-detecting network in the retail environment). As an example, the real-time data may indicate that the customer has spent considerable time in an electronics department of the retail environment, and non-real-time data may indicate that the customer has previously purchased a particular electronic gaming system. In this example, the rewards system may generate a reward offering the customer a gift card to spend on one or more games for the electronic gaming system at a third-party merchant. In this manner, the rewards system may encourage the customer to make a purchase at another merchant, for example, when the merchant associated with the retail environment does not sell the type of product or service identified for the reward. As another example, the real-time data may indicate that the customer has spent considerable time in a children's clothing department of the retail environment, and the non-real-time data may indicate that the customer has several young children. In this example, the reward may be a coupon for use at a third-party merchant, such as a toy store. Other examples are possible.

Exemplary process 600 continues at step 612 where, after the predetermined amount of time, the rewards system determines the computing device associated with the customer remains in the location-detecting network configured in the retail environment. To this end, the rewards system may, for example, detect the presence of the computing device by receiving from the location-detecting network (or a detection system that includes the location-detecting network) a detection notification indicating that the computing device is in the retail environment, as described above in connection with step 602 and FIG. 7. The detection notification may uniquely identify the customer.

At step 614, in response to determining the computing device remains in the location-detecting network configured in the retail environment, the rewards system transmits the reward to the computing device. The computing device may display the reward to the customer. In some embodiments, the reward transmitted to the computing device may itself by used in completing a purchase transaction at a payment terminal, such as payment terminal 110 described above. For example, the reward transmitted to the computing device may be stored at the computing device (e.g., in an application executed on the computing device), and the customer may present the computing device, displaying the reward, at the payment terminal during the purchase transaction. Alternatively or additionally, in some embodiments, the reward transmitted to the computing device may notify the customer that the reward has been associated with the customer in some manner, such as through a financial service account or merchant account that is associated with the customer. In these embodiments, the computing device may not be used in redemption of the reward. For example, the reward transmitted to the computing device may notify the user that the reward has been associated with the customer's financial service account, and the reward may be automatically applied when the customer pays using a financial service product associated with the financial service account, such as a credit, debit, and/or loyalty card. The reward transmitted to the computing device may take other forms as well.

While the foregoing focused on a physical retail environment, it will be understood that process 600 may be similarly implemented in an online retail environment. For example, rather than tracking the customer's physical movement through a physical retail environment, the customer's browsing through retailer websites may be monitored. One or both of real-time data and non-real-time data in such embodiments may indicate, for example, a customer's browsing (e.g., as determined using tracking cookies or another tracking technology) in the online retail environment and/or one or more additional online retail environments. One or both of real-time data and non-real-time data in such embodiments may further indicate, for example, items viewed or placed in the customer's “shopping cart” but never purchased. Other non-real-time data is possible as well. In such embodiments, for example, rewards may be conditioned on the user remaining on a particular retailer website or set of websites for a predetermined amount of time.

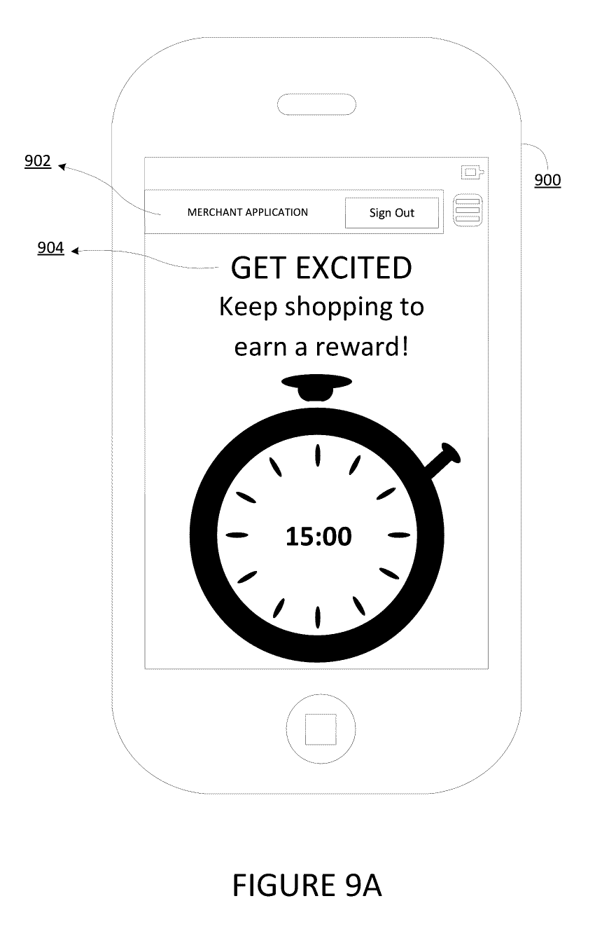

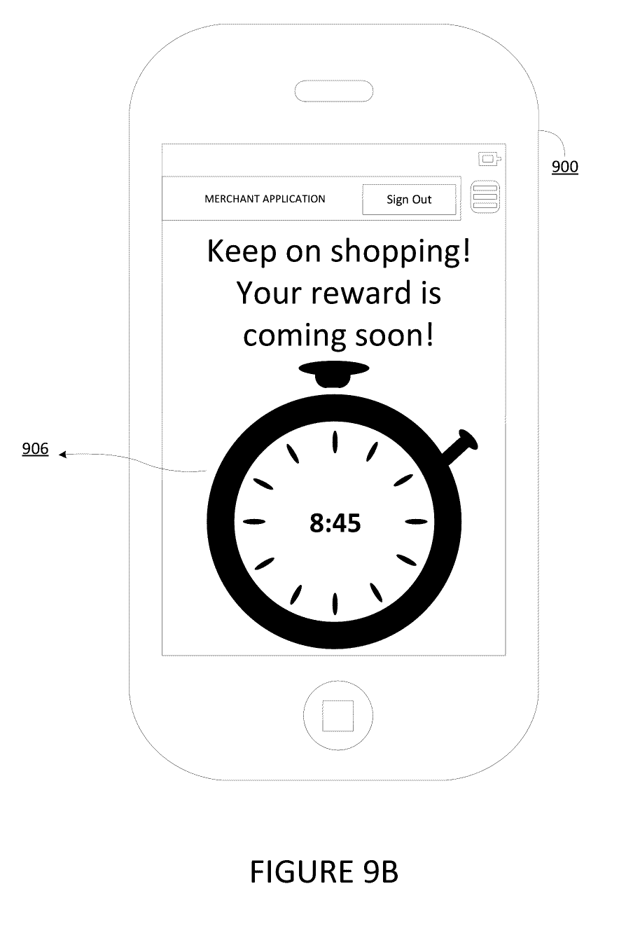

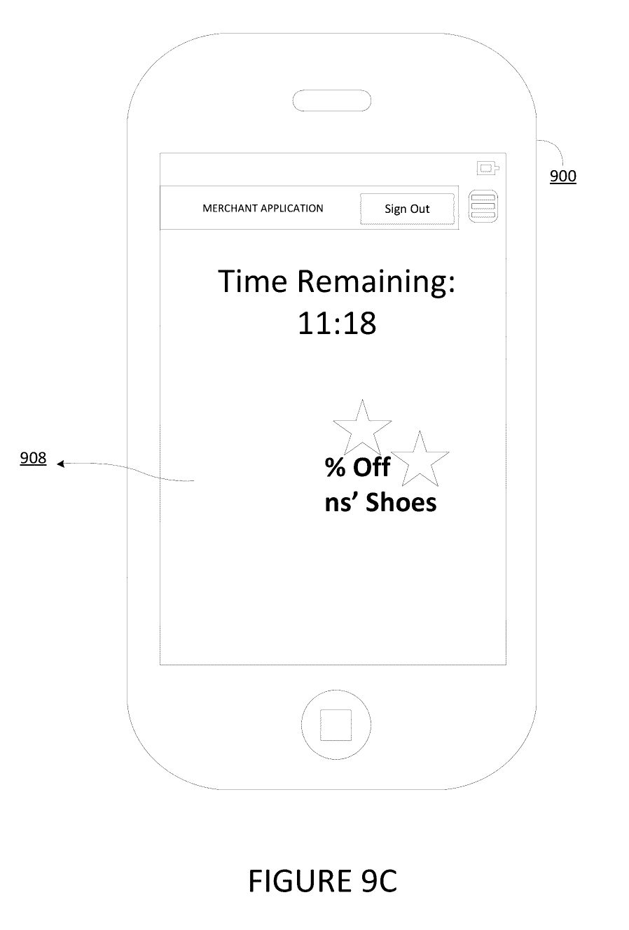

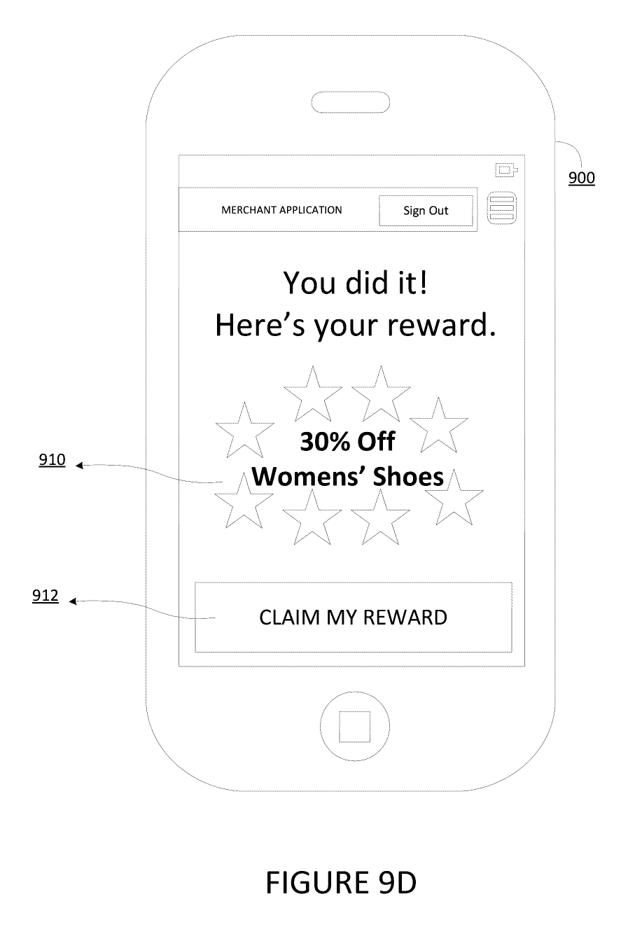

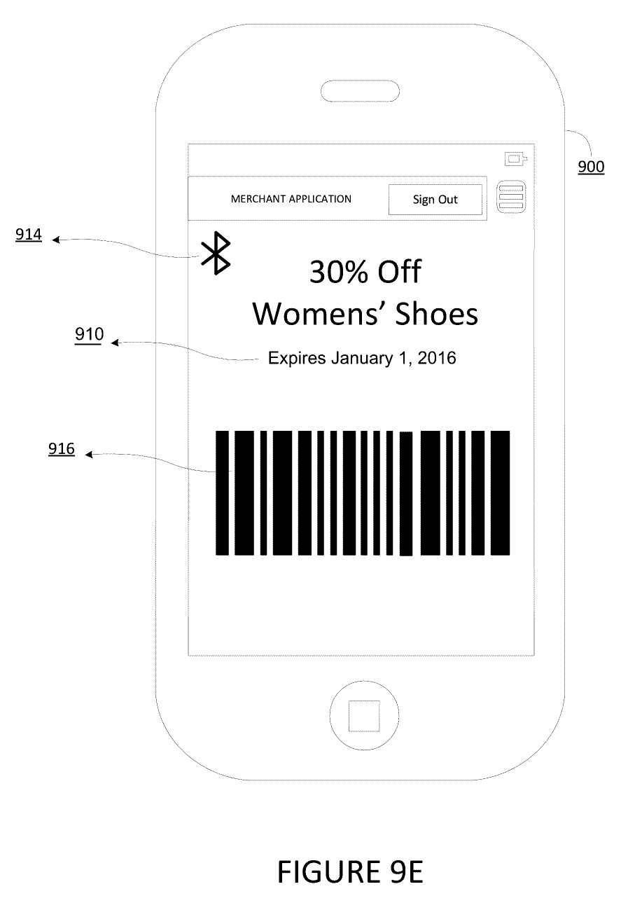

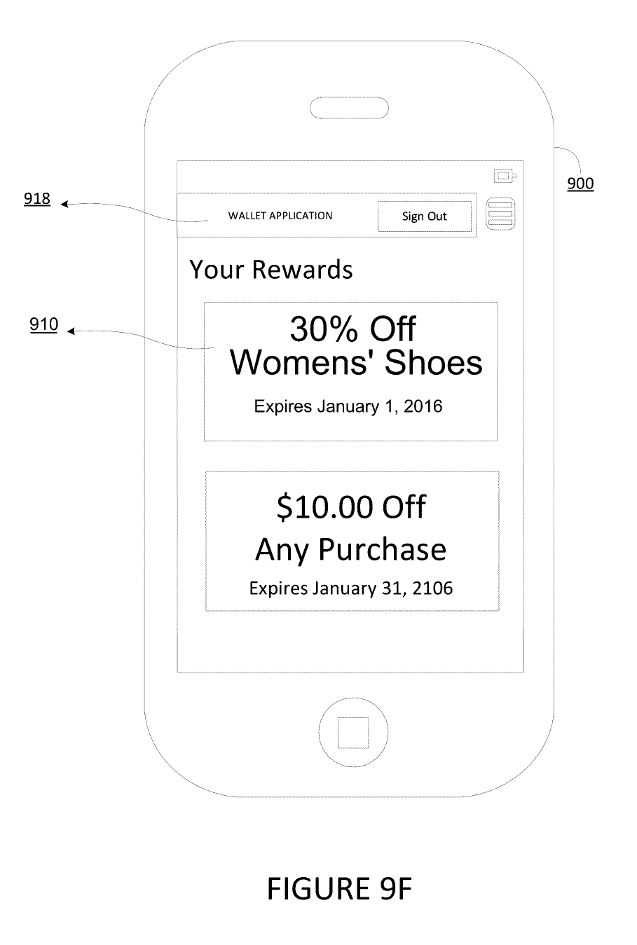

FIG. 8 is a flowchart of another exemplary reward process, consistent with disclosed embodiments. Reward process 800 may be carried out at a computing device, such as computing devices 102, 208, 312, and 500 described above. FIGS. 9A-F illustrate exemplary interfaces on a computing device 900, consistent with disclosed embodiments. Reward process 800 will be described with reference to computing device 900 of FIGS. 9A-F.

Reward process 800 may begin at step 802 where a computing device in a retail environment emits a signal uniquely identifying a customer associated with a computing device. The signal may be emitted via, for example, a detection system interface or location-detecting network interface, such as detection system interface 502 described above. The signal may be detected by a detection system or location-detecting network, such as detection systems 114, 204 or beacons 704 described above.

At step 804, in response to emitting the signal, the computing device receives an offer notification from a rewards system. The offer notification, for example, offers the customer a reward in exchange for remaining in the retail environment for at least a predetermined amount of time. The offer notification may be received via, for example, a rewards system interface, such as rewards system interface 504 described above.

An exemplary interface displaying an offer notification is shown in FIG. 9A. As shown, computing device 900 executes a merchant application 902. In other embodiments, computing device 900 may execute an application not associated with the merchant, such as a mobile banking application or an application associated with another third-party. In still other embodiments, computing device 900 may display an offer notification as a “push” notification outside of any visibly running application. The offer notification may be displayed in other manners as well. The computing device 900 may display the offer notification via a display, such as display 506 described above.

As shown, offer notification 904 offers the customer a reward in exchange for remaining in the retail environment for at least a predetermined amount of time, fifteen minutes in the current example. While a particular display, layout, predetermined amount of time, and reward are shown, it will be understood that other displays, layouts, predetermined amounts of time, and rewards are possible as well.

In some embodiments, computing device 900 (and/or the rewards system from which the offer notification was received) may begin immediately to countdown the predetermined amount of time, and the computing device 900 may display the countdown. In other embodiments, computing device 900 may display a request for acceptance by the customer (not shown). Computing device 900 may display the request via a display, such as display 506 described above. In these embodiments, upon receiving acceptance from the customer, computing device 900 may transmit a response to the rewards system indicating the customer's acceptance, and computing device 900 (and the rewards system) may then begin to countdown the predetermined amount of time. The countdown may begin in other manners as well.

Returning to FIG. 8, process 800 continues at step 806 where, during the predetermined amount of time, the computing device continues to emit the signal. In this manner, the signal may continue to be detected by the detection system or location-detecting network, thereby enabling the detection system to generate real-time data associated with the customer, as described above.

At step 808, the computing device receives the reward from the rewards system. In some embodiments, the computing device may not receive the reward until after the predetermined amount of time. In these embodiments, during the predetermined amount of time, the computing device may display a countdown 906 of the predetermined amount of time, as shown in FIG. 9B. Computing device 900 may display countdown 906 via a display, such as display 506 described above.

In other embodiments, however, computing device 900 may receive at least an indication of the reward before the predetermined amount of time has concluded. In these embodiments, computing device 900 may display, during the predetermined amount of time, a hint 908 associated with the reward, as shown in FIG. 9C. Computing device 900 may display hint 908 via a display, such as display 506 described above. Displaying hint 908 may mean, for example, displaying less than all of the reward with the amount of the reward shown increasing during the countdown, thereby allowing a customer to partially see the reward so as to build the customer's anticipation. While hint 908 is shown as partially covered, in other embodiments hint 908 may be partially transparent, may fade in, may appear letter-by-letter, or may otherwise be revealed over the predetermined amount of time. It will be understood that hint 908 may be any interface that builds the customer's anticipation of the reward.

The process 800 continues at step 810 where, after the predetermined amount of time, the computing device displays the reward. The computing device may display the reward via a display, such as display 506 described above. In embodiments where the computing device has displayed less than all of the reward as a hint, the computing device may display the reward by displaying all of the reward. An example reward 910 is shown in FIG. 9D. In some embodiments, the reward may be presented as a “scratch off” reward (not shown). Thus, the customer may interact with display 506 in such a manner as to reveal the reward, such as by swiping across the “scratch off” to reveal the underlying reward.

Upon display of reward 910, the customer may activate a button 912 to claim reward 910. In some embodiments, the customer may manually claim reward 910, e.g., through a selection on the computing device 900. In other embodiments, computing device 900 and/or the rewards system may automatically claim the reward. In either case, upon being claimed, reward 910 may be saved at computing device 900 or otherwise associated with the customer. For example, in some embodiments, computing device 900 may save reward 910 in an application running on computing device 900, such as a merchant application, a mobile banking application, or a third-party application. For example, as shown in FIG. 9E, reward 910 may be automatically saved in the merchant application, and the customer may redeem reward 910 at a payment terminal, such as payment terminal 110, using the merchant application and computing device 900. Computing device 900 may communicate with the payment terminal through any number or combination of communication technologies, such as a Bluetooth® connection 914, optical scanning 916, and/or manual entry. As another example, in some embodiments, computing device 900 and/or the rewards system may automatically associate reward 910 with the customer in some manner, such as through a financial service account or merchant account that is associated with the customer. In these embodiments, the customer may redeem reward 910 at a payment terminal, such as payment terminal 110, using a financial service product associated with the financial service account or merchant account. The financial service product may be or may be included in computing device 900 or another financial service product. In these embodiments, computing device 900 may or may not be used in redemption of reward 910. For example, in some embodiments, reward 910 may be added (e.g., stored, transferred, exported, etc.) to an electronic wallet or similar financial service product associated with the customer. The wallet may be, for example, a mobile application similar to, for example, Apple™, Apple Wallet™, and/or Google Wallet™. Other wallets are possible as well. An example wallet application 918 is shown in FIG. 9F. In these embodiments, mobile application 918 and computing device 900 may be used in redeeming reward 910 at a payment terminal, such as payment terminal 110. For example, the customer may redeem reward 910 at a payment terminal, such as payment terminal 110, using the merchant application and computing device 900, as described above. As another example, in some embodiments reward 910 may be associated with a merchant or financial service account associated with the customer. In these embodiments, a financial service product, such as a credit, debit, and/or loyalty card may be used at a payment terminal, such as payment terminal 110, to redeem reward 910. For instance, when the customer makes the purchase transaction using the financial service product, reward 910 may be automatically redeemed a financial service product associated with the financial service account. The reward transmitted to the computing device may take other forms as well. The reward may be claimed in other manners as well.

In some embodiments, the customer may be required to use the reward before leaving the retail environment. In other embodiments, the reward may require that the customer pay with a financial service product associated with a particular financial service account for the customer. In still other embodiments, the customer may be required to use the reward before a predetermined deadline. Other conditions for using the reward are possible as well.

In some embodiments, the user may redeem the claimed reward during a purchase transaction at a payment terminal, such as payment terminal 110 described above. In embodiments where the reward has been saved in an application on the computing device, the customer may present the computing device, displaying the reward, at the payment terminal. In embodiments where the reward has been associated with the customer's financial service account, the reward may be automatically applied when the customer pays using a financial service product associated with the financial service account, such as a credit, debit, and/or loyalty card. The reward may be redeemed in other manners as well.

While the foregoing described a customer being offered only a single reward, in some embodiments, after earning a reward by remaining in the retail environment for a predetermined amount of time, a customer may be offered an additional and/or increased reward for continuing to remain in the retail environment for an additional predetermined amount of time. Thus, in this manner, the process above may be repeated as determined by the merchant, financial service provider, or other entity associated with the reward(s). In this manner, the customer may be further encouraged to remain in the retail environment. Alternatively or additionally, the customer may be offered an additional or increased reward for returning to the retail environment before a predetermined deadline. Additional rewards may be offered in other manners as well.

In some examples, some or all of the logic for the above-described techniques may be implemented as a computer program or application or as a plug-in module or subcomponent of another application. The described techniques may be varied and are not limited to the examples or descriptions provided.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments. For example, while a financial service provider and merchant have been referred to herein for ease of discussion, it is to be understood that consistent with disclosed embodiments other entities may provide such services in conjunction with or separate from a financial service provider and merchant.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

1. A rewards system, comprising:
a communications interface configured to communicate with at least one of a detection system, at least one third-party server, and a computing device;
a memory storing instructions; and
a processor configured to execute instructions to perform operations comprising:
receiving, from the detection system, a first detection notification indicating a computing device associated with a customer in a first retail environment, the first detection notification uniquely identifying the customer,
in response to receiving the first detection notification, transmitting an offer notification to the computing device for display on a computing device interface, the offer notification offering the customer a reward in exchange for remaining in the first retail environment for at least a predetermined amount of time,
receiving, from the detection system, real-time data associated with the customer indicating a behavior of the customer in the first retail environment,
obtaining, from the at least one third-party server, non-real-time data associated with the customer,
generating the reward based on the real-time data and the non-real-time data,
receiving, from the detection system, a second detection notification indicating that the computing device has remained in the first retail environment for the predetermined amount of time, and
in response to receiving the second detection notification, transmitting the reward to the computing device for display on the computing device interface.

2. The rewards system of claim 1, wherein:
the first retail environment comprises a physical retail location; and
the detection system comprises a location-detecting network within the physical retail location.

3. The rewards system of claim 2, wherein the behavior of the customer in the first retail environment comprises movement of the customer within the physical retail location indicated by a detection of the computing device over time by a plurality of location detectors within the location-detecting network, the location detectors being associated with separate physical locations within the first retail environment.

4. The rewards system of claim 1, wherein the non-real-time data comprises demographic information associated with the customer.

5. The rewards system of claim 1, wherein the non-real-time data indicates at least one of previous behavior of the customer in the first retail environment and behavior of the customer in a second retail environment.

6. The rewards system of claim 1, wherein the reward comprises a coupon for a merchant associated with the first retail environment. The rewards system of claim 1, wherein the reward comprises a coupon for a third-party merchant unassociated with operation of the location-detecting network in the first retail environment.

8. The rewards system of claim 1, wherein the at least one third-party server comprises a financial service provider server.

9. A method, comprising:
detecting, in a location-detecting network configured in a first retail environment, a presence of a computing device associated with a uniquely identified customer;
in response to detecting the computing device, transmitting a notification to the computing device, the notification offering a reward in exchange for remaining in the first retail environment for at least a predetermined amount of time;
obtaining real-time data associated with the customer, the real-time data indicating a behavior of the customer in the first retail environment based on a monitored location of the computing device in the location-detecting network;
obtaining non-real-time data associated with the customer;
generating the reward based on the real-time data and the non-real-time data;
after the predetermined amount of time, determining that the computing device associated with the customer remains in the location-detecting network; and
in response to determining the computing device remains in the location-detecting network, transmitting the reward to the computing device.

10. The method of claim 9, wherein:
the retail environment comprises a physical retail location; and
detecting the presence of the computing device comprises a location detector of the location-detecting network receiving a transmission from the computing device.

11. The method of claim 10, wherein the behavior of the customer in the first retail environment comprises movement of the customer within the physical retail location indicated by a detection of the computing device over time by a at least one of plurality of location detectors within the location-detecting network, the location detectors being associated with separate physical locations within first the retail environment.

12. The method of claim 9, wherein the non-real-time data comprises demographic information associated with the customer.

13. The method of claim 9, wherein the non-real-time data indicates at least one of previous behavior of the customer in the first retail environment and behavior of the customer in a second retail environment.

14. The method of claim 9, wherein obtaining the non-real-time data comprises receiving the non-real-time data from at least one third-party server.

15. The method of claim 9, further comprising:
in response to transmitting the offer notification, receiving a response from the computing device indicating an acceptance of the offer by the customer.

16. The method of claim 9, wherein the reward comprises a coupon for a merchant associated with the first retail environment.

17. The method of claim 9, wherein the reward comprises a coupon for a third-party merchant unassociated with operation of the location-detecting network.

18. A computing device associated with a customer, the computing device comprising:
a location-detecting network interface;
a rewards system interface;
a display;
a memory storing instructions; and
a processor configured to execute instructions to perform operations comprising:
emitting, in a retail environment, via the location-detecting network interface, a signal uniquely identifying the customer,
in response to emitting the signal, receiving, from a rewards system via the rewards system interface, an offer notification, the offer notification offering the customer a reward in exchange for remaining in the retail environment for at least a predetermined amount of time,
during the predetermined amount of time, continuing to emit, via the location-detecting network interface, the signal,
receiving, from the rewards system via the rewards system interface, the reward, and
after the predetermined amount of time, displaying, via the display, the reward.

19. The computing device of claim 18, the operations further comprising, during the predetermined amount of time, displaying, via the display, a hint associated with the reward.

20. The computing device of claim 19, wherein:
displaying a hint associated with the reward comprises displaying less than all of the reward; and
displaying the reward comprises displaying all of the reward.
